(19) United States
(12) Patent Application Publication
(10) Pub. No.: US 2004/0028192 A1
(43) Pub. Date: Feb. 12, 2004

(54) TELEPHONE SET

(76) Inventor: DALE T. PELLETIER, COLORADO SPRINGS, CO (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 09/281,396

(22) Filed: Mar. 30, 1999

(51) Int. Cl. H04M 1/64; H04M 1/00; H04M 3/00

(52) U.S. Cl. 379/67.1; 379/355.01

(57) ABSTRACT

A telephone set includes a housing and a dialing interface operably connected to a plurality of dialing keys. The telephone set is provided with a message alert and retrieval device comprising a message key that is operably connected to the dialing interface and a light source that causes emission of a visible light from the message key. The light source is responsive to a message waiting signal generated by a call management interface, and the dialing interface generates a message retrieval control signal in response to activation of the message key.

### FIELD OF THE INVENTION

The invention relates generally to telephone sets, and more specifically to a telephone set having a message retrieval mechanism.

### BACKGROUND OF THE INVENTION

Since Alexander Graham Bell's invention of the telephone in 1876, development of telephones and telephone systems has led to more advanced devices with a greater number of features. Telephones have progressed from devices having no means for dialing, to those having a rotary dial, to those having touch-tone operation. Telephones have also moved increasingly from analog to digital operation.

Numerous features have also been added to the basic telephone. For example, modern telephones have electronic memories for storing numbers of frequently-dialed parties. Modern telephones may also transfer callers to other phones, be equipped with multiple lines, and enable conference calling among several parties. Furthermore, telephones can identify on visual displays the name and number of a calling party, automatically redial parties that have called in the past, display the elapsed time and cost of a call, and be operated with voice commands.

Telephone systems have also made great strides. They have moved from rudimentary patch-cord systems to sophisticated electronic switching systems. In addition, the modern business telephone is exemplified by the private branch exchange (PBX) system. A PBX system can route calls within a single site and provide access to the public telephone network. It can also be provided with additional services, such as voice mail and caller identification.

On systems equipped with a messengering service, such as voice mail, a user typically dials a central voice mail number to access a voice mail server. This can be accomplished by dialing a predetermined extension number for the voice mail server, or by pressing a key that is preprogrammed to speed dial a predetermined extension or to otherwise connect to the messaging system. A telephone may be provided with a numeric display to signify the number of messages waiting for a user in the messaging center. It is also known to equip a telephone with a light that signifies that messages are waiting for the user of the telephone. Generally, the light responds to a signal from a central messaging system. The light may be programmed to blink a certain number of times in relation to the number of messages waiting. On systems that include both a message indicator light and a message speed dial key, the user may be notified of the presence of messages by the light, and may lift up the telephone hand set and press the speed dial key to connect to the messaging system for retrieval of any messages.

### SUMMARY OF THE INVENTION

The present invention is directed toward a telephone set. In general, a telephone set in accordance with the present invention comprises a housing that defines an enclosure and a dialing interface mounted within the enclosure, where the dialing interface communicates with a call management interface. A plurality of dialing keys may be provided with the telephone set in operable connection with the dialing interface. A message alert and retrieval mechanism may also be provided. That mechanism may comprise a message key operably connected to the dialing interface and a light source that generates a visible light within a viewable surface of the message key.

Thus, message access and message indication functions can be integrated on a common key. Activation of the message key causes the dialing interface to generate a message retrieval control signal. In addition, a message waiting signal may be generated by the call management interface to activate the light source. By integrating the message access and message retrieval functions, a phone may be produced that is more intuitive to use. In particular, a user may find it easier to locate the message key when it is lit, instead of searching for a button that corresponds to a message waiting light. The user may also reach for the light with less concentration. In addition, a lighted message retrieval key may be particularly helpful in low-light conditions to help a user retrieve messages.

In one embodiment, the message key may comprise one of the plurality of dialing keys. The message key may be a touch-sensitive button, a membrane key, a touch-sensitive screen, or an icon on a graphic display. In various exemplary embodiments, the light source may be located beneath the message key, and may comprise a light-emitting diode, a light-emitting diode with a light pipe assembly, a matrix display assembly, or a light generator with a liquid crystal display element.

In another embodiment, a telephone set may be provided, comprising a housing, a plurality of dialing buttons attached to the housing, a transceiver in communication with a call management interface, a receiver attached to the housing and in communication with the transceiver, and a transmitter attached to the housing and in communication with the transceiver. A dialing interface may be connected to the dialing buttons and may be in communication with the transceiver. The telephone set may also be provided with a message alert mechanism, which comprises a message key operably connected to the dialing interface and a light source. The light source may generate a visible light signal within a viewable surface of the message key in response to a message waiting signal generated by the call management interface and received through the transceiver.

### BRIEF DESCRIPTION OF THE DRAWINGS

FIG. 1 shows a perspective view of a telephone set.

FIG. 2 shows a cross-section view of a telephone set.

FIG. 3 shows a cross-section view of another telephone set.

FIG. 4 shows a plan view of a telephone having mechanical buttons and a liquid crystal display.

FIG. 5 shows a plan view of a telephone having a graphical display.

FIG. 6 shows a plan view of a mobile telephone having mechanical buttons.

FIG. 7 shows a plan view of a mobile telephone having a graphical display.

### DESCRIPTION OF THE PREFERRED EMBODIMENTS

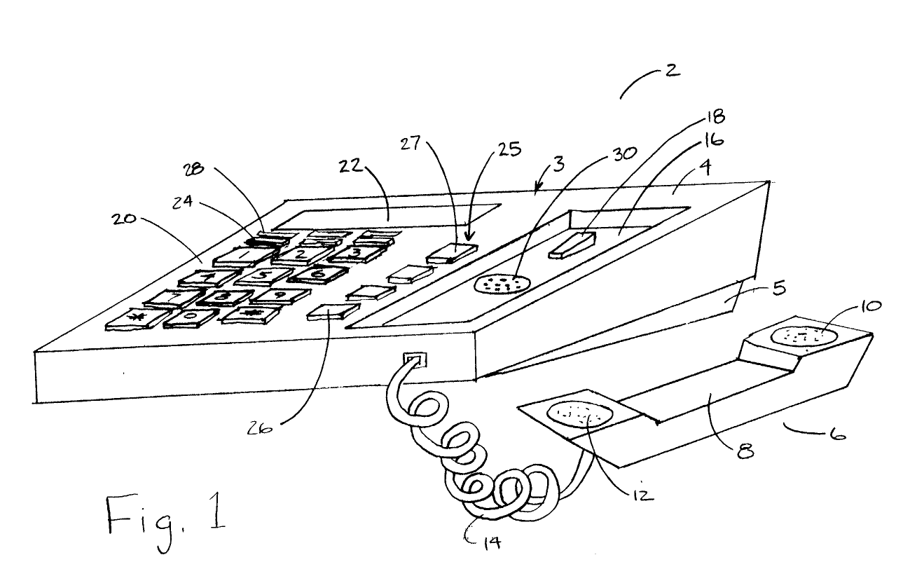

FIG. 1 is a perspective view of a telephone set. Telephone set 2 may include base unit 3 and hand set 6. Base unit 3 may be provided with a housing 4 to contain the components of base unit 3. Base unit 3 may also be provided with a stand 5 for positioning base unit 3 in a desirable orientation.

Hand set 6 may be connected to base unit 3 by way of cord 14. Cord 14 may be manufactured from any appropriate flexible, yet durable, material. Alternatively, hand set 6 may be wireless, and may be provided with a transceiver to communicate with base unit 3. Hand set 6 may be arranged with a gripping portion 8 at its center with receiver 10 at one end and transmitter 12 at the opposite end.

Base unit 3 may be provided with hand set cradle 16 to receive hand set 6. Hook switch 18 may be provided in hand set cradle 16 and may be switched to an on-hook or off-hook condition by the presence or absence, respectively, of hand set 6. Base unit 3 may also be provided with a speaker 30 that permits hands-free operation of telephone set 2.

Base unit 3 may also be provided with various keys and indicators for operating telephone set 2. Keypad 20 may be arranged as a standard dual tone multifrequency (DTMF) keypad. Key pad 20 may generate control signals to send to a call management interface, which may be part of a private branch exchange or a telephone switching station, and can interpret control signals, such as tones, from telephone set 2 and provide appropriate services in response.

Keypad 20 may be connected to a dialing interface (not shown). The dialing interface may comprise circuitry or software required to convert signals generated by actuation of keys on telephone set 2 into usable control signals. For example, the dialing interface could comprise discrete oscillator components for generating DTMF tones or could comprise integrated circuits for producing DTMF tones.

The dialing interface may also be integrated with other functions of telephone set 2, such as a speech circuit, which may be implemented on an integrated circuit, such as a Motorola MC34014. The dialing interface may also be connected to an electronic memory (not shown), e.g., EEPROM, that may retain one or more phone numbers so that a single touch of a key on a keypad sends an entire telephone number to a call management interface. Furthermore, many features may be integrated into a single microprocessor, such as a Texas Instruments TMS7000 or a Motorola MC6800, that executes program code stored in the memory.

The dialing interface, speech interface, and memories may be powered from an attached telephone line, and may be protected from voltage transients on the telephone line by appropriate circuitry. The interfaces and memories may alternatively be powered by local power, such as battery power or local power from a wall outlet.

As an alternative to keypad 20, base unit 3 may be provided with a pulse dialing mechanism. A pulse dialing mechanism represents a dialed number by a series of discrete pulses rather than by a pair of tones. Telephone set 2 may be provided with both pulse and tone dialing functionality with a combination dialing circuit, such as a circuit from the Motorola MC145412/13/512 family, or through any other appropriate means of providing dialing functionality to telephone set 2. In addition to dial tones and pulses, the dialing interface may communicate using various other control signals, whether analog or digital.

Telephone set 2 may also be provided with display 22 to provide information to the user regarding the operation of telephone set 2. Display 22 may be a liquid crystal display or any other appropriate display, and may provide information regarding the number of a dialed call, the number of an incoming call, the elapsed time of a call, the current time or date, or any other appropriate information. Display 22 may be integrated with keypad 20, for example as a touch-sensitive display. In this manner, the keys of keypad 20 may be represented as graphical icons on display 22 and may respond to touches of the keys through programming of software, executed by a microprocessor, that is responsive to signals received by a touch-sensitive portion of display 22.

Telephone set 2 may also be provided with additional functionality using function keys 26. For example, function keys 26 may be programmed to initiate common tasks, such as placing a call on hold, initiating a conference call, activating speaker 30, or transferring a call.

Function keys 24 may provide even further functionality. For example, function keys 24 may be programmed to dial frequently-called numbers. Function keys 24 could be programmable by the user so that the user may select and update the telephone numbers dialed by each key. Keys such as function keys 24 may be referred to as speed-dial buttons. Labels 28 may also be provided near function keys 24 to indicate the function to be performed by each key. Labels 28 may be permanent, for example, indicating speed-dial numbers for police, fire, or ambulance. Alternatively, labels 28 may be changeable to indicate numbers for acquaintances or clients.

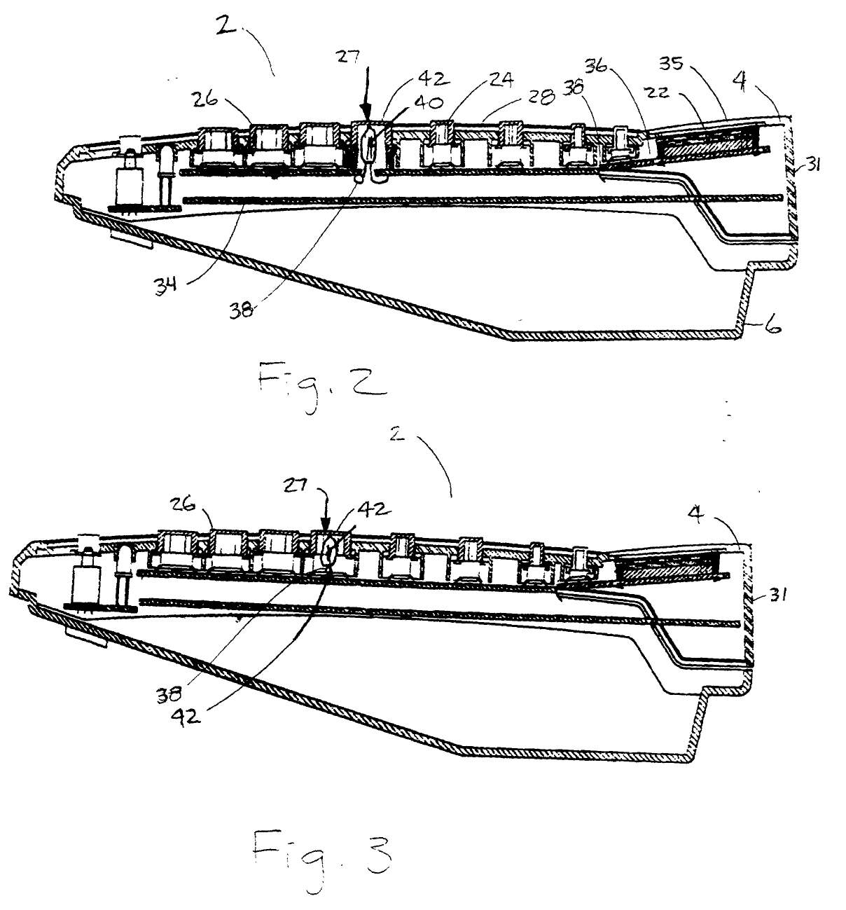

Telephone set 2 may also be provided with message alert mechanism 25. Message alert mechanism 25 is an apparatus which may exhibit dual functionality. Message alert mechanism 25 may first comprise a message key 27 that is configured to provide access to a messaging center. Message alert mechanism 25 may also comprise a light source 40 (FIGS. 2 & 3) that provides visible light to a visible portion of message key 27. The light source 40 may be responsive to a signal from a messaging center that indicates when messages are waiting for the user of telephone set 2. Thus, not only may the message alert mechanism 25 provide visual notification that messages are waiting, but it may also receive a command from the user to retrieve the messages.

Combining the notification and retrieval functions into a single mechanism may result in a compact and intuitive user interface for telephone set 2. Unlike systems in which the message notification light source 40 is placed at a distance from message key 27, the integrated message alert mechanism may lessen the need for the user to search for the message key. Typically, a user who was unfamiliar with a telephone set would not immediately know which button to push to retrieve messages. However, the decision can be made much more quickly when the button to be pushed is lit.

This feature may be particularly advantageous in low light conditions, such as in a darkened room, or when the telephone set 2 is used outdoors at night. In such situations, the user may simply aim for the light. For example, guests in hotel or motel rooms may want to retrieve voice mail messages immediately upon entering a room. However, often the light near the door provides the only light in the room, while the lights near the beds and the telephone are not on. In such a low-light condition, a user could easily find the lit button. Also, mobile phones are often used outside, and a button that lights up when messages are waiting could simplify dialing during the nighttime.

In addition, telephones generally do not have much space for providing instructions, and telephone users do not generally have the time or the inclination to read instructions. Integration of the message notification and message retrieval functions into a single mechanism may result in a reduced need for instructions on the operation of the telephone set 2, because a user would merely need to press the light to retrieve messages. Furthermore, the combined mechanism may also provide for more ready standardization from telephone set to telephone set, so that users may become even more accustomed to aiming for the light.

FIGS. 2 and 3 show cross-section views of a telephone set 2. Housing 4 may be provided with stand 5 to produce a desired orientation of telephone set 2. Housing 4 may also be provided with vents 31 to allow air to circulate within housing 4. Printed circuit board 34 may be connected to display board 36 by electrical connector 38. Display board 36 may support display 22, which may provide visual indications of the operation of telephone set 2. A transparent shield 35 may be provided to protect display 22 from scratches.

Circuit board 34 may serve many purposes. First, circuit board 34 may connect the various electronic components of telephone set 2, such as keys, lights, the microprocessor, and other circuitry. It may also serve as a mounting point for those components. In particular, circuit board 34 may be mounted near the upper portion of the enclosure defined by housing 4 so that the various keys may be mounted directly to circuit board 34. Although circuit board 34 and display board 36 are shown as two physically separate boards, it should be understood that any appropriate number or arrangement of components is permissible as required by the particular application.

Message key 27 may be provided on telephone set 2 in a location that is viewable by, and accessible by, the user of telephone set 2. Message key 27 may take any appropriate and operable form. For example, message key 27 may comprise a mechanical button that makes contact with an electrically conductive surface when it is depressed. Message key 27 may also comprise a membrane switch or an active portion of a touch-sensitive visual display. In addition, message key 27 may comprise a graphical icon on a visual display.

Message key 27 may also be one of the keys on keypad 20. To function both as a dialing key and as a message retrieval key, message key 27 may be designed to be context-sensitive. For example, the dialing interface may interpret control signals from message key 27 differently depending on whether or not messages are waiting for the user of telephone set 2. Alternatively, message key 27 may generate a message retrieval control signal if it is held down and not released for a certain amount of time.

Message key 27 may be provided with a light source 40, shown as a bulb. The upper surface 42 of message key 27 may be constructed from a translucent material so as to transmit light from light source 40 to the user. Light source 40 may be connected to circuit board 34 with leads 38. Alternatively, light source 40 could be connected to any conductor that can carry a message waiting signal. The message waiting signal may be a voltage, whether continuous or intermittent, so as to cause light source 40 to generate light and thereby indicate to the user of telephone set 2 that messages are waiting. As shown in FIG. 2, light source 40 may be connected to conductors on the bottom side of circuit board 34 by passing leads 38 through a hole in circuit board 34 and drawing leads 38 back upward. As shown in FIG. 3, bulb 40 may be connected to conductors on the top side of circuit board 34 directly with leads 38. Light source 40 may also be provided as a retrofit for existing telephones or as a simple modification for new telephones using existing circuit boards. Leads 38 may be arranged so as to reach existing contacts for a message indicating light. In this manner, wires may be run from the contacts to light source 40, or circuit board 34 may be slightly modified to have conductive paths reach to light source 40.

Light source 40 may take any appropriate form as required by the particular circumstances. For example, light source 40 may comprise a bulb, a light emitting diode, or a portion of a graphical display device, such as an active or passive-matrix display. Light source 40 may also indicate the number of waiting messages, for example, by an LCD or LED segment display, or a graphical display. Emission of light by light source 40 may be controlled by switching power on or off to light source 40, or by providing continuous power to light source 40 and providing light source 40 with a device, such as a liquid crystal device, that can be switched on or off to block light from reaching message key 27.

If light source 40 comprises a graphical display device, message key 27 may be represented to a user by a portion of the display that contrasts in intensity or color with adjoining portions of the display. In addition, the color or intensity of light source 40 could be varied, for example, to indicate the urgency of a message or to indicate that a message has already been listened to. With a touch-screen display, the location of light source 40 may be coordinated with the location of message key 27 by software that causes a microprocessor to drive the display to place an icon on the display and sense the location of a touch or click.

Light source 40 may be located beneath message key 27 or at another location that permits light from light source 40 to be seen by a user of telephone set 2 within the outer boundaries of message key 27. For example, light source 40 may be positioned in a hollow of message key 27 or may be located further beneath message key 27. In addition, light source 40 may be located away from message key 27, and light from light source 40 may be directed to message key 27, for example, with mirrored surfaces or light pipes.

Alternatively, the telephone set may be provided as a single unit. The dialing interface may be located in a housing and the keys may be connected or attached to the housing, whether directly or indirectly, and may extend from the housing or may be accessed through an opening in the housing. Furthermore, the transmitter and receiver may be attached to the housing. A transceiver may also be provided to allow wireless communication by the device. The telephone set may take the form of a cordless telephone, a cellular telephone, or another personal communicator.

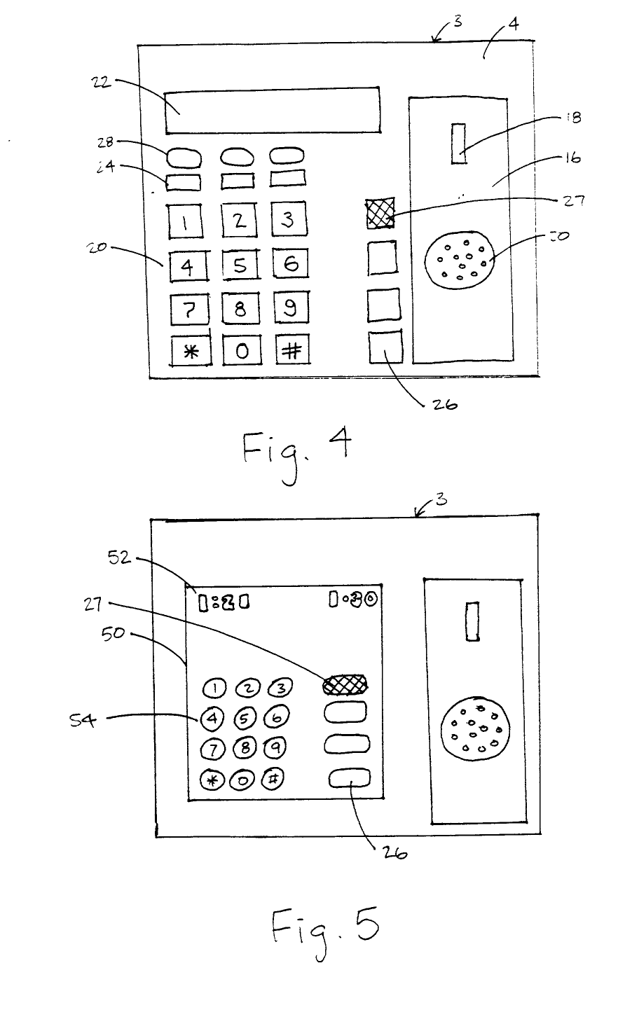

FIG. 4 shows a plan view of a base unit 3 of a telephone set having mechanical buttons for keys. Base unit 3 is provided with speaker 30 in hand set cradle 16. Key pad 20, may be provided with a grid of mechanically operated touch-tone dialing buttons that are located beneath a group of function keys 24 which may be provided with labels 28. Display 22 may be provided to indicate the status of the telephone set. The telephone set may also be provided with a plurality of functions keys 24 and message key 27. Message key 27 may have a translucent upper surface to permit light to pass through it so that the light is visible to the user of the telephone set.

FIG. 5 shows a plan view of a telephone set having a graphical display. Any or all of the keys associated with a standard telephone set may be replaced with graphical representations, or icons, representing keys on graphical display 50. Graphical display 50 may be provided with icons showing a key pad 54, function keys 26, and message key 27. Graphical display 50 may be provided with a touch-sensitive surface so that a user may touch the surface over a particular icon to produce a desired result, such as dialing a number. Message key 27 may be caused to light up in a hue or intensity that contrasts with the remainder of graphical display 50 so as to indicate the presence of a message. Touching graphical display 50 over the lit portion of message key 27 may cause the telephone set to send out a message retrieval signal.

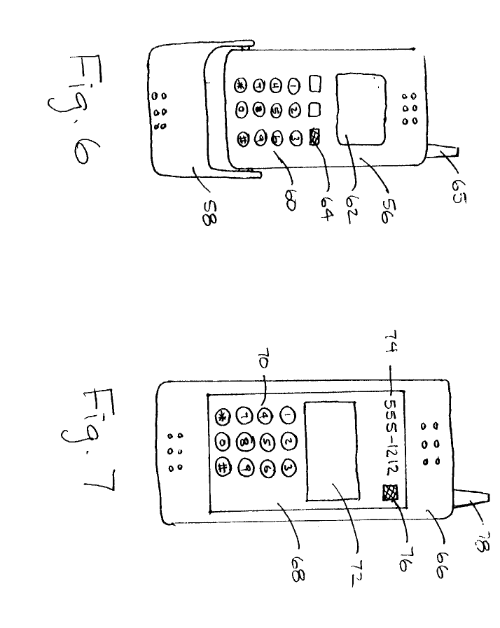

FIG. 6 shows a plan view of a wireless telephone set. The pictured telephone is of a clam-shell design, including a main body 56 attached to a flip-up microphone device 58. Main body 56 may be provided with an antenna 65, a key pad 60 containing a plurality of dialing buttons, and a display 62, which can be a graphical display, such as an LCD display, that presents information about the state of the telephone to the user. Main body 56 may also be provided with a lighted message key 64, which lights up when a message is waiting and permits speedy access to waiting messages.

FIG. 7 shows a plan view of a wireless telephone set having a graphical display 68. Graphical display 68 may produce icons that represent features such as dialing keys 70 and message key 76. All or a portion of graphical display 68 may be touch-sensitive so that a user may touch areas of the screen that correspond to certain functions, such as dialing, to cause the telephone to perform those functions. Graphical display 68 may also provide information about the operation of the telephone or other information in display area 72 and telephone number display area 74. Message key 76 may be caused to light up or otherwise differ in hue or intensity from its surroundings so as to indicate the presence of a waiting message. Message key 76 may respond to a user's touch by caused a message retrieval signal to be generated.

What is claimed is:

1. A telephone set comprising:
a) a housing;
b) a dialing interface mounted in the housing, the dialing interface being in communication with a call management interface;
c) a plurality of dialing keys operably connected to the dialing interface;
d) a message alert and retrieval device, comprising a message key operably connected to the dialing interface, and a light source that causes emission of a visible light from the message key, wherein the dialing interface generates a message retrieval control signal in response to activation of the message key, and wherein the light source is responsive to a message waiting signal generated by the call management interface.

2. The telephone set of claim 1, wherein the message retrieval control signal comprises a predetermined series of dialing digits.

3. The telephone set of claim 2, further comprising a memory in operable connection with the dialing interface, wherein the memory stores data corresponding to the predetermined series of dialing digits for initiating the message retrieval control signal.

4. The telephone set of claim 3, further comprising a central processing unit operably connected to the dialing interface, the memory, and the call management interface.

5. The telephone set of claim 1, wherein the call management interface comprises a private branch exchange.

6. The telephone set of claim 1, wherein the dialing interface generates a dual tone multifrequency signal.

7. The telephone set of claim 1, wherein the telephone set and the call management interface are connected by a telephone line.

8. The telephone set of claim 1, wherein the message key comprises one of the plurality of dialing keys.

9. The telephone set of claim 1, wherein the message key comprises a touch-sensitive button.

10. The telephone set of claim 1, wherein the message key comprises a membrane switch.

11. The telephone set of claim 1, wherein the message key comprises a graphical icon.

12. The telephone set of claim 1, wherein the light source is located directly beneath the message key.

13. The telephone set of claim 1, wherein the light source comprises a light emitting diode.

14. The telephone set of claim 13, wherein the light emitting diode is mounted below an upper surface of the message key.

15. The telephone set of claim 1, wherein the light source comprises a light emitting diode and a light pipe assembly.

16. The telephone set of claim 1, wherein the light source comprises a matrix display assembly.

17. The telephone set of claim 1, wherein the light source comprises a liquid crystal display element.

18. A telephone set, comprising:
a) a housing;
b) a dialing interface mounted in the housing;
c) a plurality of dialing keys attached to the housing and operably connected to the dialing interface;
d) a transceiver electrically connected to the dialing interface and in communication with a call management interface;
e) a message alert and retrieval device attached to the housing, comprising a message key operably connected to the dialing interface, and a light source that causes emission of a visible light from the message key, wherein the dialing interface generates a message retrieval control signal in response to activation of the message key, and wherein the light source is responsive to a message waiting signal generated by the call management interface and received through the transceiver;
f) a transmitter attached to the housing and electrically connected to the transceiver; and
g) a receiver attached to the housing and electrically connected to the transceiver.

19. A message indicator for a telephone, the message indicator comprising:
a light source that emits light when a message is waiting,
a key that, when manipulated by a user of the telephone, causes transmission of a message retrieval signal,
wherein the light source is physically integrated with the key.

20. A telephone comprising:
a message indicator light and a message access key, wherein the light is integrated with the key.
